(19) United States
(12) Patent Application Publication
(10) Pub. No.: US 2022/0371659 A1
(43) Pub. Date: Nov. 24, 2022

(54) METHOD FOR DETERMINING A STEERING RETURN MOMENT REQUIREMENT, A STEERING SYSTEM, A COMPUTER PROGRAM PRODUCT, AND A STORAGE MEDIUM

(71) Applicant: ZF Automotive Germany GmbH, Alfdorf (DE)

(72) Inventors: Peter Hambloch, Krefeld (DE); Andreas Kotz, Duisburg (DE); Martin Gebing, Vreden (DE)

(21) Appl. No.: 17/747,157

(22) Filed: May 18, 2022

(30) Foreign Application Priority Data
May 18, 2021 (DE) 10202104997.4

(51) Int. Cl. B62D 6/00; B62D 5/04

(52) U.S. Cl. CPC B62D 6/008; B62D 5/0481; B62D 5/0421

(57) ABSTRACT

The present disclosure relates to a method for determining a steering return moment requirement of a steering device of a vehicle, to a steering system, to a computer program product, and to a computer-readable storage medium. The steering device is part of a steering system of the vehicle, and is coupled to at least one actuator. The actuator is configured to apply a steering moment to the steering device. The method comprises at least the step of determining the steering return moment requirement based on at least one rack force of the steering system. The steering return moment requirement forms at least a portion of a target steering moment which can be applied to the steering device by the at least one actuator.

### CROSS-REFERENCE TO RELATED APPLICATION

This application claims priority to German Priority Application No. 102021204997.4, filed May 18, 2021, the disclosure of which is incorporated herein by reference in its entirety.

### TECHNICAL FIELD

The present disclosure relates to a method for determining a steering return moment requirement, to a steering system, to a computer program product, and to a computer-readable storage medium.

### BACKGROUND

In the case of electromechanical steering systems or steer-by-wire steering systems, a mechanical coupling of the steering device (steering wheel, joystick) to the wheel to be controlled can be dispensed with. In order to provide the user of the vehicle with a natural steering feel, despite the lack of a mechanical coupling, steering systems of this type have actuators that work together with the steering device. A target steering moment requirement is determined for the actuator. This is compared with an actual steering moment applied to the steering device, such that a corresponding actuating variable for the actuator can be determined by a control circuit. In accordance with the actuating variable, the actuator acts on the steering device in order to adapt the actual steering moment to the target steering moment, which gives the driver a natural steering feel

In this context, FIG. 1, which is a partial extract from WO 2019 115 563 A1, discloses a corresponding determination method 10 for the target steering moment requirement 22. A basic steering moment 12 is determined based on the input variables of the rack force (RackF) and the vehicle speed (Vspd). In addition, a return moment 14 is determined with the input variables steering wheel angle (Ipos), driving moment (Dmom), and the vehicle speed (Vspd). Furthermore, a damping moment 16 is determined with the input variables steering wheel angular velocity (Ivel), driver moment (Dmom), and vehicle speed (Vspd). In addition, a hysteresis moment 18 is determined based on the input variables driver moment (Dmom) and vehicle speed (Vspd). Further individual moments are possible, but are of no significance for the present disclosure. From the individual moments 12, 14, 16, 18, a sum moment 20 is then formed, which determines the target steering moment requirement 22.

However, WO 2019 115 563 A1 discloses, with regard to the return moment 14, to the damping moment 16, and to the hysteresis moment 18 that, with the exception of the vehicle speed, the only input variables that are used are those that are directly related to the input of the driver or the position or movement of the steering device (steering wheel, joystick). As a result, however, precisely the parameters that are influenced by the result of the control process are used as input variables. This is because the adjustment of the actual steering moment to the target steering moment requirement through the actuating variable that is provided for the actuator specifically influences the input variables used. In other words, changes during the tuning of the steering feel have an effect on the turning moment feedback for the driver, and thus in turn influence the functions that are dependent on the driver and that, according to the prior art, are used as input variables for determining the individual moments 14, 16, 18. As a result, the control mechanism comprises an intrinsic additional loop. Feeding back the controlled variable and using it as an input signal is at least disadvantageous in terms of control speed, delay, and therefore control stability.

In addition, the turning moment of the steering device varies with respect to the transverse acceleration of the vehicle, insofar as the steering feel is readjusted or varied (in a non-linear dependency), and is therefore less predictable. Importantly, the steering moment contains a damping component which is always dependent on the tuning of the steering feel.

In addition, the intrinsic loop can cause a notch in the steering behavior of the steering device, especially in the central position of the steering device. This occurs when the estimated driver turning moment deviates from the turning moment actually applied. Such a steering behavior is generally not desired.

Also, with regard to different vehicle parameters, for example weight as a function of equipment, the approach according to the prior art is ripe for improvement. That the use of scaling factors, a weight adjustment is taken into account, for example when determining the basic steering moment, in order to give the driver a consistent steering feel. As a result, other functions that use the steering moment as an input variable would also have to be adapted. This process involves a lot of effort, is complex, and is usually neglected.

In a similar way, according to the prior art, changes in friction of the road surface are only taken into account indirectly through the force feedback characteristic map in order to report the changes in friction to the driver.

What is needed therefore, is a method for determining a target steering moment requirement in which these disadvantages can be eliminated or at least reduced.

### SUMMARY

Among other things, a method, a steering system, a computer program product, and a storage medium are provided herein. Advantageous refinements of the disclosure are presented in the dependent claims. Individual exemplary arrangements are explained with reference to the method—others with reference to the device. The aspects are to be mutually transferred accordingly.

According to a first exemplary arrangement, a method for determining a steering return moment requirement of a steering device of a vehicle is provided. The steering device is part of a steering system of the vehicle, and is coupled to at least one actuator which is configured to apply a steering moment to the steering device. The method comprises at least the step of determining the steering return moment requirement based on at least one rack force of the steering system. The steering return moment requirement forms at least a portion of a target steering moment which can be applied to the steering device by the at least one actuator.

The rack force has a substantially fixed relative ratio to a transverse acceleration of the vehicle. As a result, the rack force is independent of a generally variable tuning or readjustment of the steering feel, which can be adapted for the driver by an actuator coupled to the steering device (steering wheel, joystick). The control loop, using the rack force, therefore has no additional intrinsic loop. The intrinsic loop which is provided in the prior art represents a damping for a hysteresis behavior of the turning moment. In contrast, the hysteresis of the rack force is lower and more consistent, since it does not include this type of damping component originating in the tuning process. Therefore, on the one hand, the determination of the steering return moment requirement is advantageously more robust with respect to an adaptation of the driving feel and, on the other hand, the control process can take place more quickly because the settling time is shortened. Due to the substantially fixed relative ratio of the rack force to the transverse acceleration, changes in friction of the road surface are also taken into account directly through the use of the rack force. Indirect consideration through the use of characteristic maps, which are necessary in the prior art, can advantageously be circumvented here. As such, the changes in friction are taken into account immediately without a time delay (no additional intermediate steps), although the determination of the steering return moment requirement is actually of reduced complexity.

Alternatively or cumulatively, the steering return moment requirement can furthermore be determined based at least on a vehicle speed, on a steering position determined by the steering system of the vehicle, and on a steering velocity determined by the steering system. As a result, the steering return moment requirement can be determined more precisely.

The steering position determined by the steering system of the vehicle can, for example, be a position of the steering device, that is to say a steering angle. The position can also be the wheel deflection based on a straight ahead position. Furthermore, the position can also be a transverse displacement of the rack or the displacement of a tie rod with respect to a normal position (central position). Information about the position can also be supplied by the drive (for example, a motor) within the steering system. The position can also be an angle of a joint associated with the steering system. The position is accordingly a position, determined by the steering system, of a part of the steering system that is displaced in relation to a normal position (straight ahead position) upon a deflection of the steering. Alternatively, the previously mentioned positions within the control device can also be determined by conversion on the basis of a reference position (example: motor position to rack position).

The steering velocity determined by the steering system of the vehicle can, for example, be a speed of the steering device, that is to say a speed of rotation of the steering device. However, the speed can also be a deflection rotation speed (steering velocity) of a wheel. Furthermore, the speed can also be a displacement speed of the rack or a displacement speed of a tie rod with respect to a normal position (central position). Information about the position can also be supplied by the drive (for example, a motor) within the steering system. The speed is accordingly a displacement, rotation or steering velocity of a part of the steering system, which is determined by the steering system and which is offset in relation to a normal position (straight ahead position) when the steering wheel is turned. Usually, the speeds mentioned above are also determined within the control device by conversion on the basis of a reference speed (example: motor speed to rack speed).

The steering return moment requirement can additionally or alternatively be determined on the basis of a proportional control loop with a proportionality factor and a base target velocity. The rack force can be taken into account both when determining the proportionality factor and when determining the base target velocity. The proportional control loop enables a particularly fast adjustment in order to determine the steering return moment requirement. The rack force is advantageously used for both sub-parameters of the proportional control loop, such that the control loop is robust and fast.

Alternatively or cumulatively, the method can also include at least the step of multiplying at least one first function value and one second function value in order to determine a product value. The first function value can be determined at least as a function of the rack force. The second function value can be determined at least as a function of the vehicle speed and of the steering position determined by the steering system. In addition, the method can include the step of subtracting the steering velocity determined by the steering position from the product value in order to determine the base target velocity of the proportional control loop, The method can also include the step of multiplying the base target velocity by a third and a fourth function value.

The third and fourth function values can together represent the proportionality factor.

The third function value can be determined at least as a function of the rack force,

The fourth function value can be determined at least as a function of the vehicle speed and the steering position determined by the steering system. As a result, both the proportionality factor and the base target velocity can be precisely determined, such that the steering return moment requirement can be determined as required.

At least one of the first to fourth function values can be determined based on at least partially defined functions and/or by characteristic curves and/or by characteristic maps and/or by look-up tables. As a result, the function values can be determined beforehand based on test measurements and made available for the driving situation.

The at least partially defined functions and/or characteristic curves and/or characteristic maps and/or look-up tables can be variable as a function of a desired steering feel. In this way, for example, the determination of the steering return moment requirement can be adapted to a desired driving style. According to the prior art, the functions, characteristic values or tables are also used to adapt the steering feel to changed suspension loads that the steering system has to carry using scaling factors. In contrast, the rack force dependency advantageously adjusts by itself the active return component for different suspension loads (vehicle parameters) of different vehicle configurations. Therefore, the functions, characteristic values or tables have fewer variables and are less complex, which improves the precision of the determination.

The rack force can be provided based on a measurement, on an estimation from a steering model, or on a vehicle model. In this respect, a sensor can be provided that measures the applied rack force in order to provide corresponding values. Models can also be used in advance to determine the rack force as a function of vehicle parameters and of a vehicle speed. This possibility is based on the substantially fixed relative ratio of the rack force to the lateral acceleration of the vehicle. Furthermore, the rack force can be based on an estimate, provided that the corresponding steering system is based on steering-dependent variables. Of course, the approaches can also be combined.

In particular, in one exemplary arrangement, the method is computer-implemented. The determination of the steering return moment requirement can accordingly be determined by a data processing unit, which has advantages in terms of speed of precision. In addition, a determination data processing unit supported in the vehicle is easy to implement, for example via a control device.

If the underlying steering system does not have a rack, but rather a central rod arranged between the tie rods, in one exemplary arrangement, the central rod force can also be used instead of the rack force to determine the steering return moment requirement. For such a central rod, too, the relative ratio to the transverse acceleration of the vehicle is substantially fixed.

According to a second exemplary arrangement, a steering system for a vehicle is provided. The steering system comprises at least one steering device, a rack, a control device and at least one actuator. The control device is coupled to the actuator. The control device is configured to determine a steering return moment requirement of the steering device according to the method described above. The steering return moment requirement forms at least a portion of a target steering moment which can be applied to the steering device by the at least one actuator. The steering system thus makes it possible to define the steering return moment requirement accordingly and to act on the steering device accordingly, as a result of which the driver is given an improved steering feel because the determination is made more quickly and more precisely.

Alternatively or cumulatively, the control device can comprise at least one processor and be coupled to a storage device. Functions and/or characteristic curves and/or characteristic maps and/or look-up tables that are at least partially defined are stored in the storage device, such that at least one of the first to fourth function values can be determined by the control device based on data from the storage device. Using the storage device, the predetermined; measured, modeled or estimated function values can also be made available to the control device for processing for different configurations of the steering feel.

The steering system can furthermore comprise at least one sensor, by which a rack force applied to the rack can be measured. The rack force can thus advantageously be measured independently of time. The respective measured value can then be made available to the control device for determining the steering return moment requirement.

The steering system can be a steering-by-wire steering system or an electromechanical steering system. The determination of the steering return moment requirement can therefore be used in particular for steering systems that do not have a mechanical coupling between the steering device, and have steerable components that are used to directly change the direction of the vehicle.

All of the features explained with regard to the second exemplary arrangement can be transferred to the first exemplary arrangement individually or in (partial) combination.

According to a third exemplary arrangement, a computer program product is provided. The computer program product comprises instructions which, when the program is executed by a computer, cause the computer to determine the steering return moment requirement according to the method described herein.

According to a fourth exemplary arrangement, a computer-readable storage medium is provided. The storage medium comprises instructions which, when the program is executed by a computer, cause the computer to determine a steering return moment requirement based on at least one rack force of the steering system.

All of the features explained with regard to the third and fourth exemplary arrangements can be transferred individually or in (partial) combination to the first and/or second exemplary arrangements, as well as vice versa.

The present disclosure can also be improved in that a steering hysteresis requirement and/or a steering damping requirement is also incorporated into the method, the steering system, the computer program product and the storage medium, as will be explained below.

As such, in this case a total target moment requirement is determined which comprises the steering return moment requirement as well as a steering hysteresis requirement and/or a steering damping requirement. Scaling factors can be taken into account. The individual totals are determined based at least on the rack force as described herein. The resulting advantages accrue cumulatively to the total target moment requirement.

According to an optional fifth exemplary arrangement, the method according to the disclosure can consequently also be supplemented by a method for determining a steering hysteresis requirement of a steering device of a vehicle. The supplementary method can comprise or consist of the step of determining the steering hysteresis requirement based on at least one rack force of the steering system. The steering hysteresis requirement can therefore form a portion of a target steering moment applied to the steering device by the at least one actuator (the total target moment requirement).

The steering hysteresis requirement can also be determined based at least on a vehicle speed, on a steering position determined by the steering system of the vehicle, and on a steering velocity determined by the steering system. This enables the steering hysteresis requirement to be determined more precisely.

Alternatively or cumulatively, the steering hysteresis requirement can be characterized by an absolute limit value and an absolute slope value. The rack force can then be taken into account both when determining the absolute limit value and when determining the absolute slope value of the steering hysteresis requirement. The rack force may be advantageously used for both sub-parameters of the steering hysteresis requirement, such that the hysteresis can be determined robustly and quickly.

The method can furthermore at least also include the step of multiplying at least one first function value and one second function value in order to determine the absolute limit value of the steering hysteresis requirement. The first function value can be determined at least as a function of the rack force, and the second function value at least as a function of the vehicle speed. In addition, the method can include the step of multiplying a third function value and a fourth function value in order to determine the absolute slope value of the steering hysteresis requirement.

The third function value can be determined as a function of at least the absolute limit value of the steering hysteresis requirement, the steering position determined by the steering system, the steering velocity determined by the steering system, and the steering hysteresis requirement.

The fourth function value can be determined as a function of at least the vehicle speed. As a result, both the limit value of the steering hysteresis requirement and the slope value of the steering hysteresis requirement can be precisely determined, such that the steering hysteresis requirement as a whole can be determined as required.

At least one of the first to fourth function values can be determined based on at least partially defined functions and/or by characteristic curves and/or by characteristic maps and/or by look-up tables. As a result, the function values can be determined in advance based on test measurements, and made available for the driving situation.

The at least partially defined functions and/or characteristic curves and/or characteristic maps and/or look-up tables can be variable as a function of a desired steering feel. In this way, for example, the determination of the steering hysteresis requirement can be adapted to a desired driving style. According to the prior art, the functions, characteristic values or tables are also used to adapt the steering feel to changed suspension loads that the steering system has to carry using scaling factors. In contrast, the rack force dependency advantageously itself adjusts the steering hysteresis requirement for different suspension loads (vehicle parameters) of different vehicle configurations. Therefore, the functions, characteristic values or tables have fewer variables and are less complex, which improves the precision of the determination.

If the underlying steering system does not have a rack, but a central rod arranged between the tie rods, the central rod force can also be used instead of the rack force to determine the steering hysteresis requirement. For such a central rod, too, the relative ratio to the transverse acceleration of the vehicle is substantially fixed.

According to an optional sixth exemplary arrangement, the steering system according to the disclosure can have a control device which is configured to determine a steering hysteresis requirement of the steering device according to the method described above. The steering hysteresis requirement can form at least a portion of a target steering moment applied to the steering device by the at least one actuator. The steering system thus makes it possible to determine the steering hysteresis requirement accordingly, and to act on the steering device accordingly, as a result of which the driver is given an improved steering feel because the determination is made more quickly and more precisely.

If the steering system is a steering-by-wire steering system or an electromechanical steering system, the determination of the steering hysteresis requirement can be used in particular for steering systems that do not have a mechanical coupling between the steering device, and have steerable components that are used to directly change the direction of the vehicle.

All of the features explained with regard to the sixth exemplary arrangement can be transferred individually or in (partial) combination to the fifth exemplary arrangement.

According to an optional seventh exemplary arrangement, the computer program product according to the disclosure can comprise commands which, when the program is executed by a computer, cause the computer to determine the steering hysteresis requirement according to the method described herein.

According to an optional eighth exemplary arrangement, the computer-readable storage medium according to the disclosure can comprise instructions which, when the program is executed by a computer, cause the computer to determine a steering hysteresis requirement based on at least one rack force of the steering system.

All of the features explained with regard to the seventh and eighth exemplary arrangements can be transferred individually or in (partial) combination to the fifth and/or sixth exemplary arrangement, as well as vice versa.

According to an optional ninth exemplary arrangement, the method according to the disclosure can also be coupled with a determination of a steering damping requirement of a steering device of a vehicle—with and without the aforementioned method for determining a steering hysteresis requirement of a steering device. The additional method for determining a steering damping requirement can include the step of determining the steering damping requirement based on at least one rack force of the steering system. The steering damping requirement can therefore form a portion of a target steering moment applied to the steering device by the at least one actuator.

The steering damping requirement can also be determined based at least on a vehicle speed, on a steering position determined by the steering system of the vehicle, and on a steering velocity determined by the steering system. This allows the steering damping requirement to be determined more precisely.

Alternatively or cumulatively, the determination of the steering damping requirement can also include at least the step of multiplying at least one first function value and one second function value. The first function value can be determined at least as a function of the rack force. The second function value can be determined at least as a function of the vehicle speed, the steering position determined by the steering system, and the steering velocity determined by the steering system. As a result, the steering damping requirement can be determined in an uncomplicated and tailored manner.

At least one of the first to second function values can be determined based on at least partially defined functions and/or by characteristic curves and/or by characteristic maps and/or look-up tables. As a result, the function values can be determined in advance based on test measurements, and made available for the driving situation.

The at least partially defined functions and/or characteristic curves and/or characteristic maps and/or look-up tables for determining the steering damping requirement can be variable as a function of a desired steering feel. In this way, for example, the determination of the steering damping requirement can be adapted to a desired driving style. According to the prior art, the functions, characteristic values or tables are also used to adapt the steering feel to changed suspension loads that the steering system has to carry using scaling factors. In contrast, the rack force dependency advantageously adjusts by itself the active return component for different suspension loads (vehicle parameters) of different vehicle configurations. Therefore, the functions, characteristic values or tables have fewer variables and are less complex, which improves the precision of the determination.

The rack force can be provided based on a measurement, on an estimation from a steering model, or on a vehicle model. In this respect, a sensor can be provided that measures the applied rack force in order to provide corresponding values, Models can also be used in advance to determine the rack force as a function of vehicle parameters (for example, dimensions) and to determine a vehicle speed. This possibility is based on the substantially fixed relative ratio of the rack force to the lateral acceleration of the vehicle. Furthermore, the rack force can be based on an estimate, provided that the corresponding steering system is based on steering-dependent variables, vehicle parameters, and the vehicle speed. Of course, the approaches can also be combined.

The method supplemented by the determination of the steering damping requirement can also be computer-implemented. The determination of the steering damping requirement can accordingly be determined by a data processing unit, which has advantages in terms of the speed of precision.

If the underlying steering system does not have a rack, but rather a central rod arranged between the tie rods, the central rod force can also be used instead of the rack force to determine the steering damping requirement. For such a central rod, too, the relative ratio to the transverse acceleration of the vehicle is substantially fixed.

According to an optional tenth exemplary arrangement, the steering system according to the disclosure can also be configured to determine a steering damping requirement of the steering device according to the method described herein. The steering damping requirement can form at least a portion of a target steering moment applied to the steering device by the at least one actuator. The steering system thus makes it possible to determine the steering damping requirement accordingly, and to act on the steering device accordingly, as a result of which the driver is given an improved steering feel because the determination is made more quickly and more precisely.

As already mentioned, the control device can comprise at least one processor and be coupled to a storage device. At least partially defined functions and/or characteristic curves and/or characteristic maps and/or look-up tables for determining the steering damping requirement can be stored in the storage device, such that at least one of the first to second function values can be determined by the control device based on data from the storage device. The processor can be designed in such a way that it determines the steering damping requirement according to the method described herein.

If the steering system comprises at least one sensor by which a rack force applied to the rack can be measured, the respective measured value can be made available for the control device to determine the steering damping requirement, 100631 The determination of the steering damping requirement can be used in particular for steering systems that do not have a mechanical coupling between the steering device, and that have steerable components that are used to directly change the direction of the vehicle.

All of the features explained with regard to the tenth exemplary arrangement can be transferred individually or in (partial) combination to the ninth aspect.

According to an optional eleventh exemplary arrangement, the computer program product according to the disclosure can comprise commands which, when the program is executed by a computer, cause the computer to determine the steering damping requirement according to the method described herein.

According to an optional twelfth exemplary arrangement, the computer-readable storage medium according to the disclosure can comprise instructions which, when the program is executed by a computer, cause the computer to determine a steering damping requirement based on at least one rack force of the steering system.

All of the features explained with regard to the eleventh and twelfth exemplary arrangements can be transferred individually or in (partial) combination to the ninth and/or tenth exemplary arrangements, as well as vice versa.

### BRIEF DESCRIPTION OF DRAWINGS

The disclosure and further advantageous exemplary arrangements and developments thereof are described and explained in more detail below with reference to the examples shown in the drawings. The features found in the description and the drawings can be used individually or collectively in any combination according to the disclosure. In the drawings:

FIG. 1 is a simplified schematic illustration of the determination of a total steering moment requirement according to the prior art,

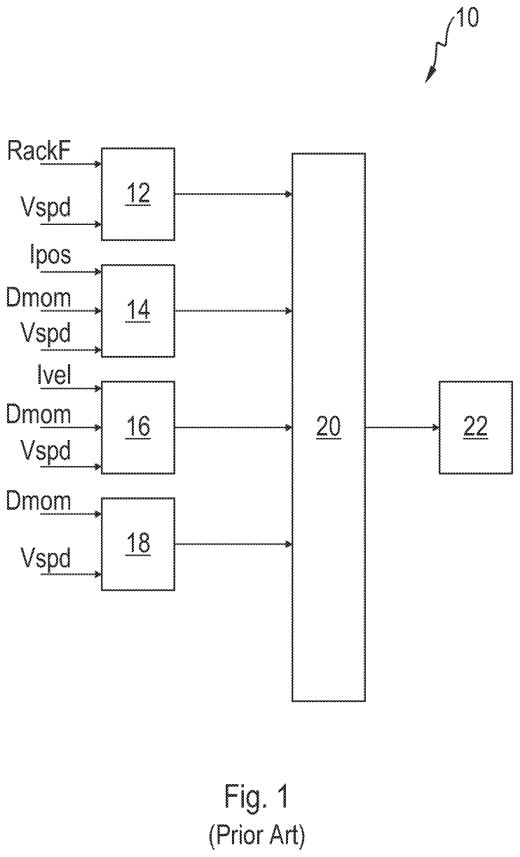

FIG. 2 is a simplified schematic illustration of a steering system,

FIG. 3 is a simplified schematic illustration of the determination of the steering return moment requirement according to an exemplary arrangement,

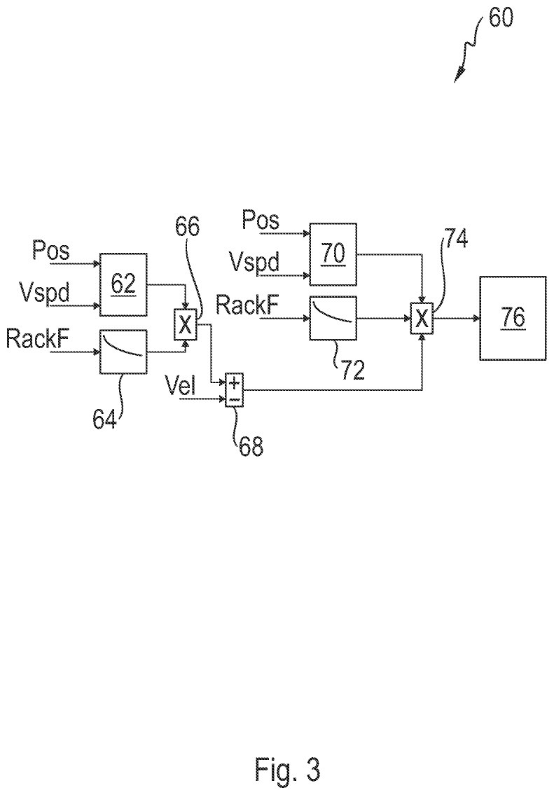

FIG. 4 is a simplified schematic illustration of the determination of the steering hysteresis requirement according to an exemplary arrangement, and

FIG. 5 is a simplified schematic illustration of the determination of the steering damping requirement according to an exemplary arrangement.

### DETAILED DESCRIPTION

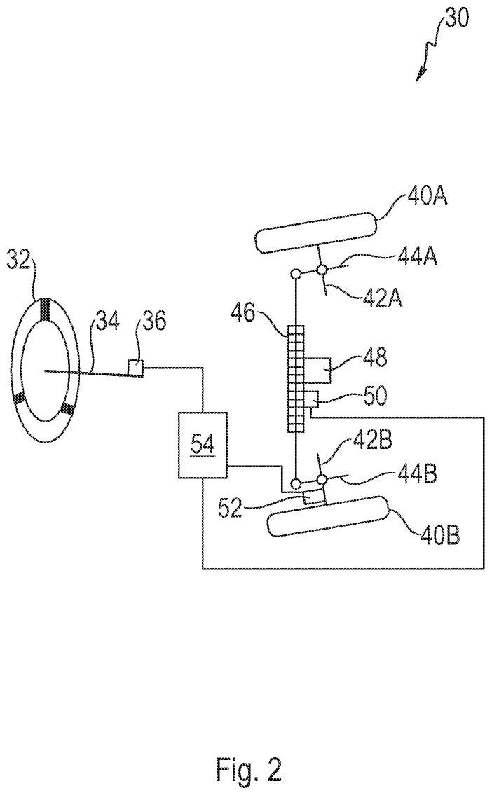

FIG. 2 is a simplified schematic illustration of a steering system 30. The steering system 30 comprises a steering device 32, in this case a steering wheel. The steering device 32 is coupled to an axle 34. An actuator 36, which interacts with the axle 34, is arranged on the axle. An actuating variable can be applied to the actuator 36 in order to exert a torque on the axle 34 as a function of the actuating variable, and thus to report a desired steering feel to the driver.

The steering device 32 and its axle 34 are mechanically separated from the rest of the steering system 30, of which the steerable wheels 40A, 40B are shown here by way of example.

The wheels 40A, 40B are each coupled to a wheel carrier 42A, 42B, each of which in turn is coupled to a tie rod 44A, 44B, A rack 46 is arranged between the tie rods 44A, 44B. The rack 46 provides a mechanical coupling for the wheels 40A, 40B so that they are always aligned parallel to one another.

An actuator 48 (pinion) is coupled to the rack 46 and can move the rack out of its central position in order to cause the wheels 40A, 403 to deflect relative to their normal position.

In addition, a sensor 50 is coupled to the rack 46, and measures the rack force. Alternatively, the detected values thereof can be used to infer the rack force. For example, in one exemplary arrangement, the sensor 50 can be a strain gauge.

There is also a second sensor 52. The second sensor 52 is configured to determine a relative position of the wheel carrier 42A with respect to its normal position. This relative position represents a steering position determined by the vehicle's steering system. The sensor 52 is also configured to measure the rotational speed of the wheel carrier 42A with respect to the center of rotation when the position of the wheel 40B changes. Of course, this does not mean the wheel rotation, but the steering rotation. This rotation speed represents a steering velocity determined by the vehicle's steering system.

The steering system further includes a control device 54 which has a processor. The control device 54 is coupled both to the actuator 36 and to the sensors 50, 52. The sensors 50, 52 transmit corresponding measured values for the rack force, the steering position, and the steering velocity to the control device 54. In addition, the control device 54 receives information about the vehicle speed. The vehicle speed can optionally also be determined by the sensor 52 or by further suitable devices.

The control device 54 is configured to determine at least a steering return moment requirement and/or a steering hysteresis requirement and/or a steering damping requirement based on the information received. Alternatively or cumulatively, the control device 54 can also determine a total target moment requirement from a desired combination of the individual moments.

The control device 54 can optionally be coupled to a storage device in which partially defined functions, characteristic values or reference tables can be stored to enable their use for the determination by the control device 54.

Optionally, the control device 54 can be configured to compare the determined steering moment requirement to an actual steering moment. An actuating variable for the actuator 36 can then be determined and transmitted to it in order to match the actual steering moment to the steering moment requirement. In any case, the determined steering moment requirement is the variable on which the control of the actuator 36 is based in order to convey the desired steering feel to the driver.

FIG. 8 shows a simplified schematic illustration of the determination of the steering return moment requirement according to an exemplary arrangement 60.

A first function value is determined in block 62 as a function of a steering position Pos determined by the steering system of the vehicle and the vehicle speed Vspd. A second function value is determined in block 64 as a function of the rack force RackF. The first and second function values are multiplied in block 66 to determine a product value. The steering velocity Vel determined by the steering system of the vehicle is then subtracted from the product value in block 68. In this way, a base target velocity is determined.

In block 70, a third function value is determined based on a steering position Pos determined internally by the steering system or externally in the vehicle and the vehicle speed Vspd. In block 72, a fourth function value is determined based on the rack force RackF, The third and fourth function values represent a proportionality factor. The third and fourth function values are then multiplied in block 74 by the product value from block 68, that is to say the base target velocity. As a result, the steering return moment requirement can be determined in block 76.

The blocks 62, 64, 70, 72 can include functions and/or characteristic values and/or characteristic maps and/or reference tables that are at least partially defined in order to be able to adapt the values determined in each case to a desired driving experience.

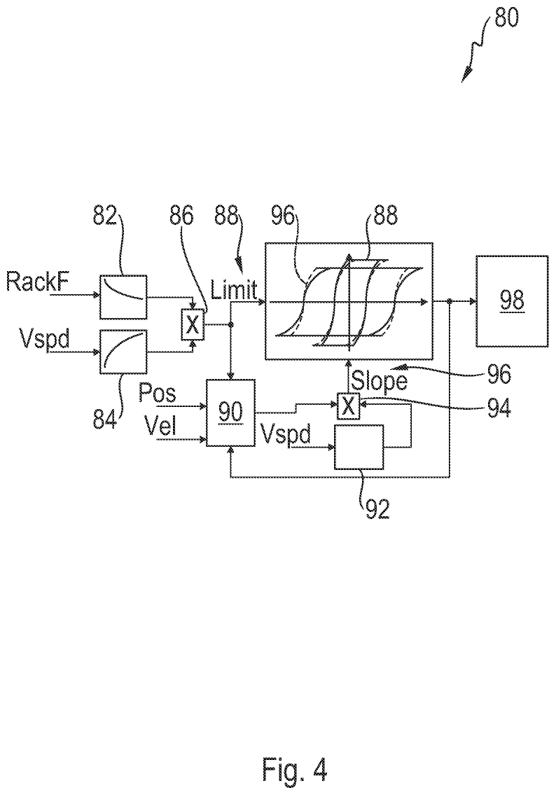

FIG. 4 shows a simplified schematic illustration of the determination of the steering hysteresis requirement according to an exemplary arrangement 80.

In block 82, a first function value is determined as a function of the rack force RackF. In block 84, a second function value is determined based on the vehicle speed Vspd. The first and second function values are multiplied in block 86. As a result, an absolute limit value (limit) of the steering hysteresis requirement is determined.

In addition, a third function value is determined in block 90 based on the steering position Pos determined by the steering system, the steering velocity Vel determined by the steering system, and the limit value determined beforehand. As an additional input variable for determining the third function value, block 90 includes a feedback loop, such that the determined steering hysteresis requirement is also taken into account.

In block 92, a fourth function value is determined based on the rack force RackF.

The third and fourth function values are multiplied in block 94 in order to determine the absolute slope value (slope) of the steering hysteresis requirement.

As a result, the steering hysteresis requirement is determined both in the limit value and in the slope, such that the situation-dependent steering hysteresis requirement is determined in block 98.

The blocks 82, 84, 90, 92 can include functions and/or characteristic values and/or characteristic maps and/or reference tables that are at least partially defined in order to be able to adapt the values determined in each case to a desired driving experience.

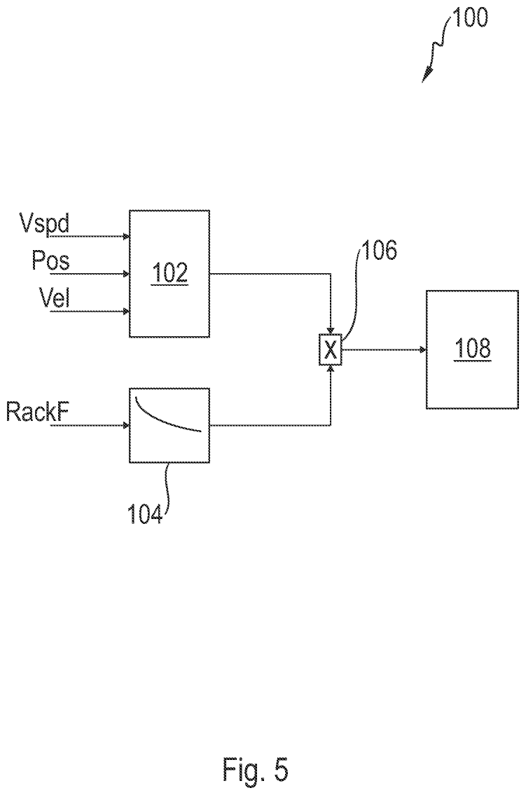

FIG. 5 shows a simplified schematic illustration of the determination of the steering damping requirement according to an exemplary arrangement 100.

A first function value is determined in block 102 as a function of a vehicle speed Vspd, a steering position Pos determined by the steering system of the vehicle, and a steering velocity Vel determined by the steering system of the vehicle. Based on the rack force RackF, a second function value is determined in block 104. The first and second function values are multiplied in block 106 in order to determine the steering damping requirement in block 108.

The blocks 102, 108 can include functions and/or characteristic values and/or characteristic maps and/or reference tables that are at least partially defined in order to be able to adapt the values determined in each case to a desired driving experience.

The steering return moment requirement, the steering hysteresis requirement, and/or the steering damping requirement can advantageously be combined with one another in any combination by finding a total target moment requirement from these. The actuator 36 is then actuated on the basis of this total target moment requirement in order to create an optimal driving experience.

While the disclosure has been shown and described with respect to one or more implementations, those skilled in the art, upon reading and understanding this specification and the accompanying drawings, will identify equivalent changes and modifications. Furthermore, while a particular feature of the disclosure may have been disclosed in relation to only one of several implementations, that feature may be combined with one or more other features of the other implementations.

1. A method for determining a steering return moment requirement of a steering device of a vehicle, wherein the steering device is part of a steering system of the vehicle and is coupled to at least one actuator which is configured to apply a steering moment to the steering device, the method having the step of:
determining the steering return moment requirement based on at least one rack force of the steering system, wherein the steering return moment requirement forms at least a portion of a target steering moment with which the steering device can be acted upon by the at least one actuator.

2. The method according to claim 1, wherein the steering return moment requirement is further determined based at least on one of a vehicle speed, a steering position determined by the steering system of the vehicle, and a steering velocity determined by the steering system.

3. The method according to claim 1, wherein the steering return moment requirement is determined using a proportional control loop with a proportionality factor and a base target velocity, and wherein the rack force is taken into account both when determining the proportionality factor and when determining the base target velocity.

4. The method according to claim 3, the method further comprising at least the steps of:
multiplying at least one first function value and one second function value in order to determine a product value, wherein the first function value is determined at least as a function of the rack force, and wherein the second function value is determined at least as a function of a vehicle speed and of a steering position determined by the steering system,
subtracting a steering velocity determined by the steering position from the product value in order to determine the base target velocity of the proportional control loop, and
multiplying the base target velocity by a third and a fourth function value, wherein the third function value is determined at least as a function of the rack force, and the fourth function value is determined at least as a function of the vehicle speed and of the steering position determined by the steering system.

5. The method according to claim 4, wherein at least one of the first to fourth function values is determined based on at least partially defined functions and/or by characteristic curves and/or by characteristic maps and/or by look-up tables.

6. The method according to claim 5, wherein the at least partially defined functions and/or characteristic curves and/or characteristic maps and/or look-up tables are variable as a function of a desired steering feel.

7. The method according to claim 1, wherein the rack force is provided based on one of a measurement, an estimation from a steering model, or a vehicle model.

8. The method according to, claim 1, wherein the method is computer-implemented.

9. A steering system for a vehicle, the steering system comprising at least one steering device, a rack, a control device and at least one actuator, wherein the control device is coupled to the actuator,
wherein the control device is configured to determine a steering return moment requirement of the steering device according to the method according to claim 4, and wherein the steering return moment requirement forms at least a portion of a target steering moment with which the steering device can be acted upon by the at least one actuator.

10. The steering system according to claim 9, wherein the control device is configured to determine the steering return moment requirement, wherein the control device comprises at least one processor and is coupled to a storage device, wherein at least partially defined functions and/or characteristic curves and/or characteristic maps and/or look-up tables are stored in the storage device, such that at least one of the first to fourth function values can be determined by the control device based on data from the storage device, and wherein the processor is designed in such a way that it determines the steering return moment requirement.

11. The steering system according to claim 9, the steering system further comprising at least one sensor by which a rack force applied to the rack can be measured.

12. The steering system according to claim 9, wherein the steering system is a steering-by-wire steering system.

13. A computer program product, comprising instructions which, when the program is executed by a computer, cause the computer to determine the steering return moment requirement according to the method according to claim 1.

14. A computer-readable storage medium, comprising instructions which, when a program is executed by a computer, cause the computer to determine a steering return moment requirement based on at least one rack force of the steering system.

15. The method according to claim 2, wherein the steering return moment requirement is determined using a proportional control loop with a proportionality factor and a base target velocity, and wherein the rack force is taken into account both when determining the proportionality factor and when determining the base target velocity.

16. The method according to claim 15, the method further comprising at least the steps of:
multiplying at least one first function value and one second function value in order to determine a product value, wherein the first function value is determined at least as a function of the rack force, and wherein the second function value is determined at least as a function of the vehicle speed (Vspd) and of the steering position (Pos) determined by the steering system (30),
subtracting the steering velocity (Vel) determined by the steering position from the product value in order to determine the base target velocity of the proportional control loop, and
multiplying the base target velocity by a third and a fourth function value, wherein the third function value is determined at least as a function of the rack force (RackF), and the fourth function value is determined at least as a function of the vehicle speed (Vspd) and of the steering position (30) determined by the steering system (Pos).

17. The method according to claim 16, wherein the rack force is provided based on one of a measurement, an estimation from a steering model, or a vehicle model.

18. The method according to claim 17, wherein the method is computer-implemented.

19. A steering system for a vehicle, the steering system comprising at least one steering device, a rack, a control device and at least one actuator, wherein the control device is coupled to the actuator,
wherein the control device is configured to determine a steering return moment requirement of the steering device according to the method according to claim 1, and wherein the steering return moment requirement forms at least a portion of a target steering moment with which the steering device can be acted upon by the at least one actuator.

20. The steering system according to claim 9, wherein the steering system is an electromechanical steering system.
